(19) United States
(12) Patent Application Publication
(10) Pub. No.: US 2009/0070232 A1
(43) Pub. Date: Mar. 12, 2009

(54) Method and system of valuing vehicles and providing classified listings

(76) Inventor: Trevor R. Milton, St. George, UT (US)

Correspondence Address: TERRENCE J. EDWARDS;CLAYTON, HOWARTH & CANNON, P.C., P.O. BOX 1909, SANDY, UT, 84091, US

(21) Appl. No.: 11/900,195

(22) Filed: Sep. 10, 2007

(51) Int. Cl. G06Q 30/00; G06F 17/00

(52) U.S. Cl. 705/27; 705/400

(57) ABSTRACT

A system and method for providing comparative market values in conjunction with creating or browsing online sales listings. Sellers automatically receive comparative market values while creating sales listings to thereby facilitate the establishment of sales prices. Potential buyers are provided comparative market values for items listed in sales listings while viewing the listings. Whether creating or viewing sales listings, comparative market values are provided automatically and without the need for the buyer or seller to link out to third-party websites to obtain the information. The present system and method are particularly suitable for operators of e-commerce websites, including auction websites and online classified websites.

### CROSS-REFERENCE TO RELATED APPLICATIONS

Not Applicable.

### BACKGROUND

1. The Field of the Invention

The present disclosure relates generally to e-commerce websites, and more particularly, but not necessarily entirely, to e-commerce websites that allow sellers to post sales listings that are searchable by potential buyers.

2. Description of Related Art

In the past decade, selling and buying products online has seen rapid growth. Various different types of websites offer different methods to sell and buy items. A seller may create his or her own website and sell directly to consumers. Alternatively, a seller may post a sales listing on an e-commerce website operated by third parties. Third-party websites include, inter alia, auction websites and online classified websites. An auction website allows buyers to place bids on items for sale. At the end of a predetermined time, the buyer with the highest bid “wins” the auction. An online classified website allows sellers to place a classified ad or listing similar to traditional advertisements placed in newspaper. In the online classified environment, the seller typically sets a sales price for the item up for sale. However, even in the online auction environment, a seller may set a quasi sales price, including a minimum sales price, e.g., a reserve or hidden minimum price, and a buy-it-now sales price, which allows a buyer to skip the auction completely and buy the item at the set buy-it-now price.

Whether selling the item directly through his or her own website or through a third-party website, a seller typically creates an online sales listing. The sales listing may include uploaded digital images of the item for sale, a description of the item for sale, and any other information about the item, including terms of payment, location of the item, and the seller's contact information. A sales listing also typically includes the seller's asking price for the item, which is referred to herein as the “sales price.” Once created, the sales listing is stored in a searchable database. Buyers may conduct queries of the database to locate desired items through a user interface.

Many third-party websites include features that allow sellers to create sales listings using a user interface. The user interface may include drop-down boxes and check boxes with common features of items to easily allow a seller to create an online sales listing. Further, a user interface may include text entry boxes to allow a seller to further describe the item for sale and enter a sales price. The user interface may also access a database with common information, including the seller's contact information. The user interface may also allow a seller to upload digital images of items for sale to be included within the sales listing.

In the past, third-party websites have been deficient in assisting sellers with setting realistic sales prices for items. Often, when creating a sales listing, a seller may have to simply guess at a fair sales price for an item. Further, while sellers have had access to independent pricing guides in the form of booklets and online websites, including Kelley Blue Books and NADA®, the information has not been directly and automatically available to the seller while creating a sales listing. That is, in the past, sellers were required to independently seek and obtain outside pricing information.

The previously available systems and methods are thus characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a block diagram of a system pursuant to one exemplary embodiment of the present disclosure;

FIG. 2A is an exemplary webpage with a data entry form operable to allow a seller to create a sales listing;

FIG. 2B is another exemplary webpage with a data entry form to allow a seller to create a sales listing;

FIG. 3 is an exemplary webpage illustrating comparative market value information that is displayed to a seller; and

FIG. 4 is an exemplary webpage illustrating comparative market value information that is displayed to a buyer.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. Further, in describing and claiming the present disclosure, the following terminology will be used in accordance with the definitions set out below. As used herein, the terms “comprising,” “including,” “containing,” “having,” “characterized by,” and grammatical equivalents thereof are inclusive or open-ended terms that do not exclude additional, unrecited elements or method steps.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software code, sometimes referred to as computer readable instructions, for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

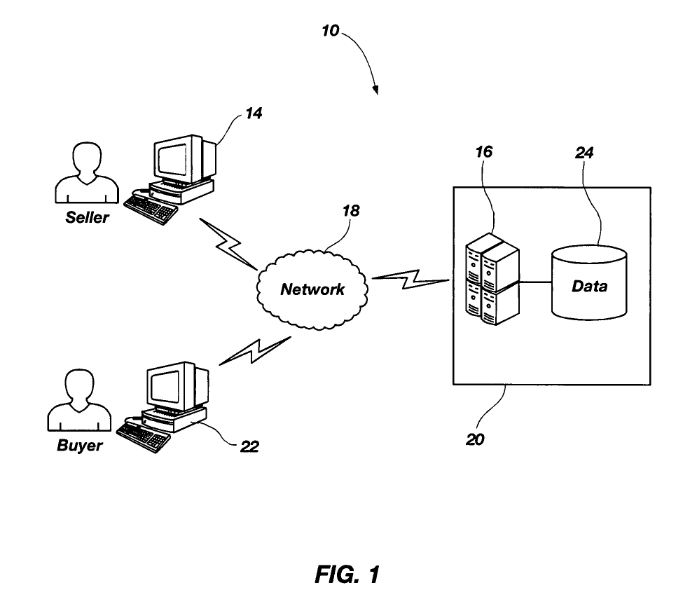

Referring now to the drawings wherein like reference numerals indicate like elements, there is depicted in FIG. 1 a block diagram illustrating a system 10 for allowing a seller to create a sales listing for an item for sale. Using a remote computing device 14, a seller may initiate a session with a server 16. The remote computing device 14 may take various forms, including a laptop computer, a desktop computer, a hand held computer, or a mobile phone. The remote computing device 14 may include user input devices, such as a keyboard, a computer mouse, or a touchscreen, allowing the seller to interface and control the operation of the remote computing device 14 and carry out those tasks attributed to the seller herein. The remote computing device 14 may be connected to a network, such as a local area network (LAN) or a wide area network (WAN). Additionally, the remote computing device 14 may be connected to a global network such as the Internet.

A suitable remote computing device 14 will now be described in more detail below. As mentioned, the remote computing device 14 may have various forms, including a desktop PC, a laptop, a portable form, or a hand held form. The features of the remote computing device 14 described herein may be integrated or separable from the remote computing device 14. For example, while the remote computing device 14 may have a monitor, it may be integrated into the remote computing device 14, such as the case of a laptop, a cell phone, a hand held personal digital assistant, or a tablet type computer.

The remote computing device 14 may include a system memory and a system bus that interconnects various system components including the system memory to a processing unit. The system bus may be any of several types of bus structures including a memory bus or memory controller, a peripheral bus, and a local bus using any of a variety of bus architectures as is known to those having skill in the relevant art. The system memory may include read only memory (ROM) and random access memory (RAM). A basic input/output system (BIOS), containing the basic routines that help to transfer information between elements within the remote computing device 14, such as during start-up, is stored in the ROM. The remote computing device 14 may further include a hard disk drive for reading and writing information to a hard disk, a magnetic disk drive for reading from or writing to a removable magnetic disk, and an optical disk drive for reading from or writing to a removable optical disk such as a CD ROM, DVD, or other optical media.

It will be appreciated that the hard disk drive, magnetic disk drive, and optical disk drive may be connected to the system bus by a hard disk drive interface, a magnetic disk drive interface, and an optical disk drive interface, respectively. The drives and their associated computer-readable media provide nonvolatile storage of computer readable instructions, data structures, program modules and other data for the remote computing device 14. Although the exemplary environment described herein employs a hard disk, a removable magnetic disk, and a removable optical disk, it will be appreciated by those skilled in the relevant art that other types of computer readable media which can store data that is accessible by a computer, such as magnetic cassettes, flash memory cards, digital video disks, Bernoulli cartridges, random access memories, read only memories, and the like, may also be used in the exemplary operating environment.

A number of program modules may be stored on the hard disk, magnetic disk, optical disk, ROM or RAM, including an operating system, one or more applications programs, other program modules, and program data. The application programs may include programs suitable for accomplishing the features and tasks described herein. The seller may enter commands and information into the remote computing device 14 through input devices such as a keyboard and a pointing device, such as a mouse. These and other input devices are often connected to the processing unit through a serial port interface that is coupled to the system bus. Increasingly, such devices are being connected by the next generation of interfaces, such as a universal serial bus interface with a USB port, and to which other hubs and devices may be connected. Other interfaces (not shown) that may be used include parallel ports, game ports, and the IEEE 1394 specification.

A monitor or other type of display device is also connected to the system bus via an interface, such as a video adapter. In addition to the monitor, the remote computing device 14 typically includes other peripheral output or input devices. For example, an ultra slim XGA touch panel may be used. A resistive finger touch screen may also be used. Further, it is well understood by those having the relevant skill in the art that a keyboard, scanner, printer, external drives (e.g., hard, disk and optical) and a pointing device may be connected to the remote computing device 14. In addition, the remote computing device 14 may be capable of communicating with a network and sending/receiving audio, video and data.

The remote computing device 14 may operate in a networked environment using logical connections to one or more remote computers or electronic devices as described herein. The types of connections between networked devices include dial up modems, e.g., a modem may be directly used to connect to another modem, ISDN, xDSL, cable modems, wireless and include connections spanning users connected to the Internet. The remote computer may be another personal computer, a server, a router, a network PC, a peer device or other common network node, and typically includes many or all of the elements described in relation to the remote computing device 14. In particular, the remote computing device 14 may be able to communicate with the electronic devices described herein.

When used in a LAN networking environment, the remote computing device 14 is connected to a local network through a network interface or adapter. The remote computing device 14 may also connect to the LAN via through any wireless communication standard, such as the 802.11 wireless standard. When used in a WAN networking environment, the remote computing device 14 typically uses modem or other means for establishing communications over the wide area network. It should be noted that the modem may be internal or external and is connected to the system bus. It will be appreciated that the network connections described herein are exemplary and other means of establishing a communications link between the computers may be used, e.g., from a LAN gateway to WAN.

Generally, the data processors of the remote computing device 14 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The disclosure described herein includes these and other various types of computer-readable storage media when such media contain instructions or programs for implementing the steps described herein in conjunction with a microprocessor or other data processor. The disclosure also includes the remote computing device 14 itself when programmed according to the methods and techniques described herein.

Loaded into the secondary memory of the remote computing device 14 may be a web browser application. The web browser application may allow a seller to locate and display webpages available on the Internet. Suitable browsers include, inter alia, Netscape Navigator, Microsoft Internet Explorer, and Firefox.

Using the remote computing device 14 and a web browser application running on the remote computing device 14, the seller is able to access a website on the server 16 over a network 18. The server 16 may be part of an e-commerce operation 20 operated by a third-party, i.e., a party that is not the seller. The e-commerce operation 20 may allow sellers to post items for sale online on the website. The e-commerce operation 20 may further allow the sellers, through the features of the website, to place items for sale in an auction type format or a more traditional online classified listing. Once a sales listing has been posted by a seller, potential buyers may search the listings through the website.

The server 16 may comprise at least two modules, a seller module and a buyer module. Each of these will now be explained. The seller module provides the features and functionality that allow a seller to create a sales listing from the remote computing device 14. The seller module may include individual webpages containing user interfaces that may be served by server 16 to the remote computing device 14. The webpages allow a seller, with the aid of the user interfaces contained in the webpages, to complete all of the steps necessary to create a sales listing. First, the seller module may provide a login webpage in response to a request from the remote computing device 14. The login webpage will allow a seller to create a login, which typically includes a username and password. The login information is stored in a database residing on an electronic storage medium 24 in communication with the server 16.

Once logged in, a seller may create and manage sales listings. To create a new sales listing, the seller may enter an appropriate command through a user interface displayed at the remote computing device 14. In response to a request to create a new sales listing, the seller module, through the server 16, may provide a webpage containing a user interface to the remote computing device 14. This user interface may allow a seller to enter information about the item for sale. It will be appreciated that the item for sale may be any item capable of transfer of ownership, including vehicles, such as cars, boats, airplanes, and real and personal property. Thus, the following description may use an automobile, for exemplary purposes only, but it should be noted that any item capable of transfer of ownership may be used by the present disclosure.

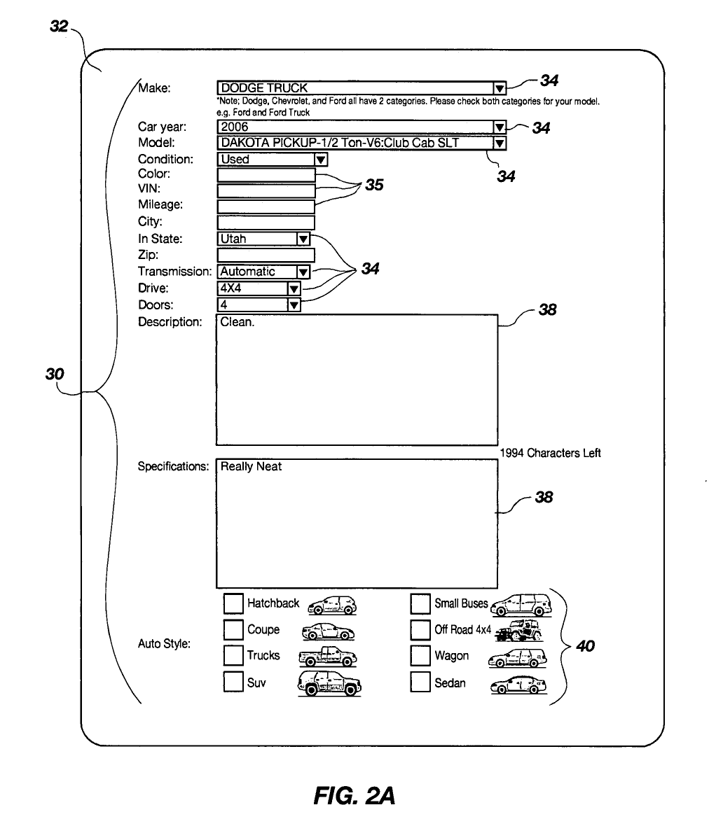

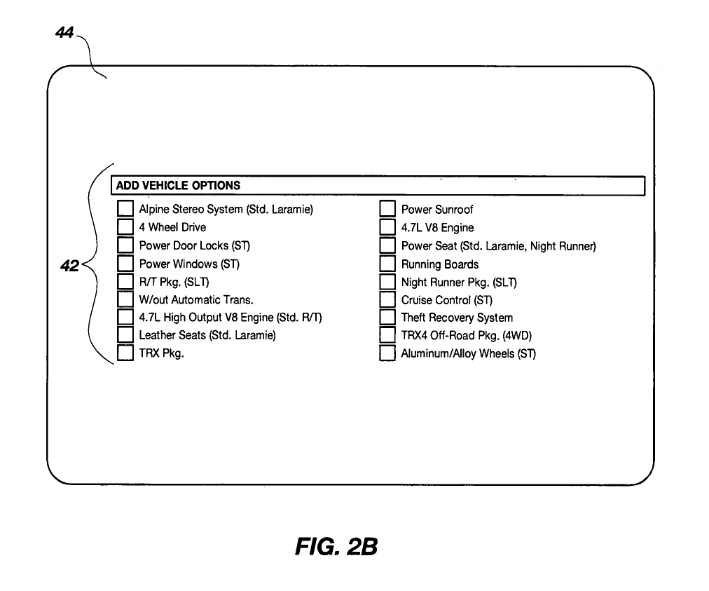

Common features of particular items may be contained in drop down boxes with pick lists. FIG. 2A illustrates an exemplary data entry form 30 that may be displayed on a webpage 32 at the remote computing device 14. The data entry form 30 depicted in FIG. 2A allows a seller to enter information about a vehicle, for example an automobile, for sale. The present disclosure, however, is not limited to just vehicles and automobiles as it may be utilized to sell any item.

The data entry form 30 may comprise drop-down boxes 34. It will be noted that the drop-down boxes 34 may include common features of a vehicle. For example, the drop-down boxes may include common features of an automobile, including make, year, model, condition, year, location, transmission type, drive type, doors. Through these drop down boxes 34, a seller is able to easily enter the features of an automobile for sale using a computer mouse. The data entry form 30 may also include text boxes 35 for allowing a seller to enter the vehicle color, VIN number, vehicle mileage, and the city where the vehicle is located.

It will be appreciated that the data entry form 30 may include or use VIN decoding, where the seller enters the VIN of a specific vehicle and the information connected with that VIN automatically fills in the vehicle make, model and other features of that particular vehicle. Such VIN decoding may help the seller match a specific vehicle to its specifications based on the VIN, which may be utilized to help the seller more easily input the correct information about the vehicle.

The data entry form 30 may also provide a description box 36 and specification box 38 to allow a seller to type in any further details germane to selling the desired automobile. The seller may also upload digital images of the automobile for sale. Check boxes 40 may allow a seller to enter an auto style. After the seller has entered the information into the data entry form 30, the seller may be presented with another data entry form 42 on a webpage 44 as shown in FIG. 2B. The data entry form 42 may allow the seller to identify additional features of the item for sale.

It will be appreciated that the above examples of entering data may be used alone, in combination or even with other methods of entering data about an item, such as a vehicle or automobile. Further, it will be appreciated that there may be other methods of entering data about an item, such as a vehicle or automobile, other than drop-down menus, pick lists, text boxes, description boxes and check boxes and such methods of entering data fall within the scope of the present disclosure.

After the seller has entered the desired information describing the automobile for sale using data entry forms 30 and 42, the information is transmitted from the remote computing device 14 to the server 16 via the network 18. It will be noted that at this point, the seller has not been able to enter a set sales price for the automobile using either of the data entry forms 30 and 42. Based upon the information entered by the seller describing the automobile, the seller module is then able to determine a comparative market value for the automobile. The comparative market value may comprise one or more of a trade-in value for the automobile, a low value for the automobile, an average value of the automobile, and a high value of the automobile.

The comparative market value of the automobile may be determined by any number of means, including market surveys and actual sales information of similar automobiles, including both current and historical sales. It will be appreciated that providing such a comparative market value to sellers and buyers alike in conjunction with creating or viewing a sales listing allows sellers and buyers to stay focused on one website without leaving the website. More specifically, sellers and buyers do not have to leave the website or switch back and forth between two websites to obtain comparative market value information. In other words, a user does not have to link out of the currently viewed webpage to third party pricing guides or websites to obtain comparative market value information or to do their own market valuation research before finalizing a sales listing. Indeed, it will be appreciated that the comparative market value can be determined by any number of methods and still fall within the scope of the present disclosure. The comparative market value may be calculated in real time or stored in a database residing on the electronic storage medium 24 for retrieval when needed.

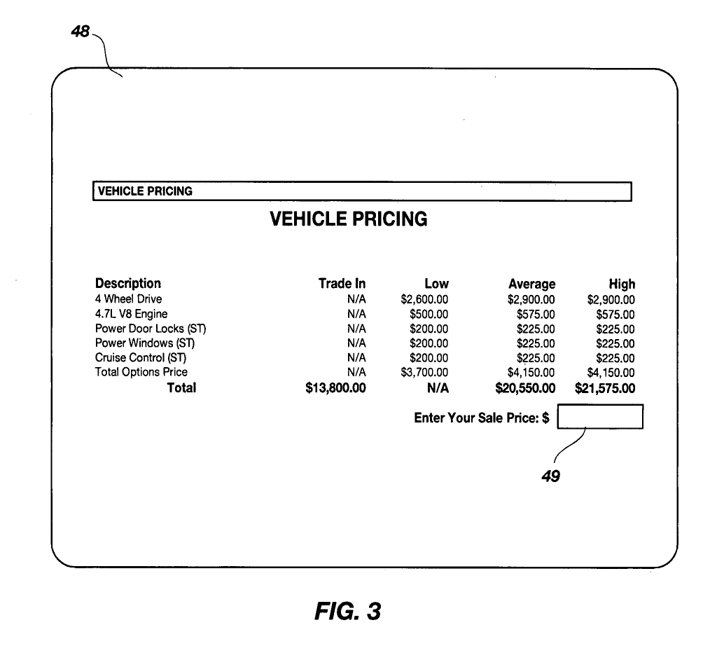

Once the seller module has determined a comparative market value for the automobile, the server 16 returns it to the remote computing device 14 where it is displayed to the seller. An exemplary webpage 48 illustrating this feature is illustrated in FIG. 3. As can be observed from FIG. 3, the seller may then enter the sales price in box 49 for the automobile after reviewing the comparative market value for the automobile. Once entered by the seller, the sales price is transmitted from the remote computing device 14 to the server 16. The seller module then generates a sales listing that includes the information previously entered in data entry forms 30 and 42 (FIGS. 2A & 2B) and the sales price entered in box 49. The seller may be provided with a preview of the sales listing. The sales listing is then made available through the server 16 for searching by potential buyers as will be explained below.

It will be appreciated that the present disclosure is not limited to the above embodiment described for creating a sales listing for an automobile. The present disclosure may be utilized to facilitate the generation of any item for sale using the principles described herein.

Referring now back to FIG. 1, there is further depicted a remote computing device 22 wherein a buyer may access the server 16 through the network 18. The remote computing device 22 may take substantially the same form as the remote computing device 14 as explained in detail above. Based upon the input of the buyer, the remote computing device 22 establishes a session with server 16. Once established, the buyer module provides, through the server 16, a user interface to the buyer. The user interface, typically in the form of a webpage, is transmitted to and displayed on the remote computing device 22. The user interface may allow the buyer to easily form queries of the sales listings stored in the database residing on the electronic storage medium 24. Thus, the buyer is able to find desired items. A query result, typically containing multiple sales listings, may be displayed on the remote computing device 22. The buyer is able to click on any of the sales listings for additional information regarding a particular sales listing.

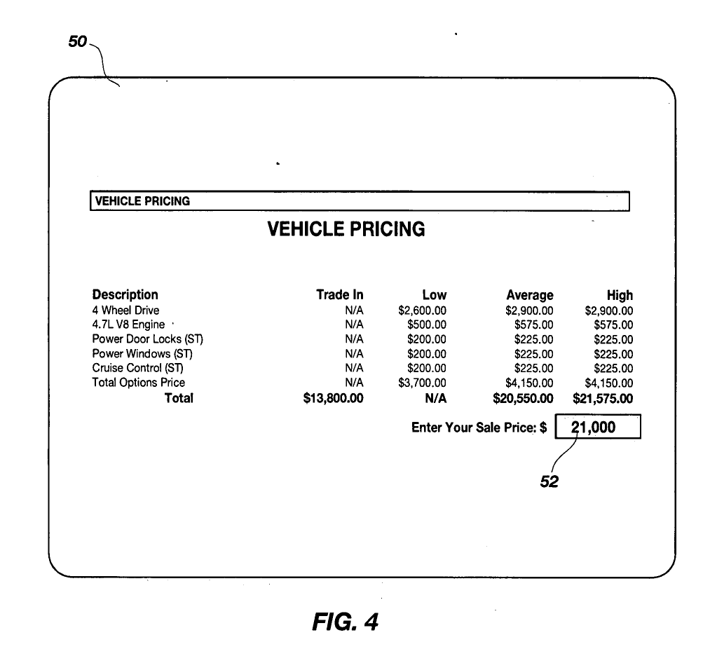

As illustrated in FIG. 4, a continuation of the automobile embodiment given in regards to FIGS. 2 and 3 above, when a buyer selects a sales listing, the buyer is automatically shown a comparative market value for the item displayed in the sales listing on a webpage 50 along with a sales price 52. Again the comparative market value may include one or more of a trade-in value for the automobile, a low value for the automobile, an average value of the automobile, and a high value of the automobile. As before, the comparative market value of the automobile may be determined by any number of means, including market surveys and actual sales information of similar automobiles, including both current and historical sales. Indeed, it will be appreciated that the comparative market value can be determined by any number of methods and still fall within the scope of the present disclosure. The comparative market value may be calculated in real time or stored in a database residing on the electronic storage medium 24 for retrieval when needed.

It should be noted that the server 16 may take various forms, including a computing device similar to the remote computing device 12 described in detail above. In addition the server 16 may comprise one or multiple computing devices acting collectively to accomplish the functions described herein. These multiple computing devices may include a web server and an application server. A web server should be understood to mean a computing device connected to a network that is running a computer application that is operable to serve web pages to remote computing devices. An application server should be understood to mean a computing device that is running a computer application that is operable to perform the business logic necessary to accomplish the features described herein. It will be understood that the web server and the application server may be “running” on the same computer as software applications.

The server 16 may include a central processor and other computing components necessary to carry out the functions described herein. In one embodiment, the server 16 may be a host computer on a network that holds information (e.g., websites) and responds to requests for information from it (e.g., links to another webpage). The term “server” is also used to refer to the software that makes the act of serving information possible. In one embodiment, the server 16 may be an e-commerce server that uses software to run the main functions of an e-commerce website, such as product display, online ordering, and payment options. In addition, the software may allow sellers to create sales listings. The software may allow buyers to search sales listings.

The server 16 will further be understood to be one or more computing devices running software that is a means for carrying out any one or more of the following tasks: providing an electronic data entry form over a network to remote computing devices, the electronic data entry form allowing sellers to enter descriptions of items for sale through remote computing devices; determining comparative market values of items for sale based upon their descriptions entered by the sellers; displaying comparative market values in a manner such that the sellers may utilize the comparative market values to finalize set sales prices for the items and receiving set sales prices for the items entered by the sellers; generating online sales listings for items from descriptions of the items entered by sellers and set sales prices; storing online sales listings in a searchable database; displaying sales listings to buyers in conjunction with the comparative market values; and allowing sellers to upload digital images of items for sale.

It will be appreciated that the embodiment described above may be utilized with online classified listings where sellers offer an item at a set price. It should be noted, however, that the present disclosure is also suitable for use with auction-based websites. The present disclosure may be utilized to assist sellers using auction-based websites. Sellers often set “buy-it-now” prices and minimum selling prices for items listed for sale on auction-based websites. During the creation of a sales listing on an auction-based website, while a seller does not set a sales price, comparative market values would be useful in establishing a “buy-it-now” price and a minimum selling price. Likewise, potential buyers bidding on items may be provided with comparative market values using the present disclosure in conjunction with a sales listing.

Those having ordinary skill in the relevant art will appreciate the advantages provided by the features of the present disclosure. For example, it is a feature of the present disclosure to provide a comparative market value to assist sellers in setting a sales price and to buyers to ensure that they do not pay above fair market value. Another feature of the present disclosure is to provide such a comparative market value to sellers and buyers in conjunction with creating or viewing a sales listing. In this manner, sellers and buyers to do not have to link out to third party pricing guides or websites to obtain comparative market value information. The comparative market value may be provided automatically and accurately to sellers and buyers in an integrated e-commerce website at the time of the creation of a sales listing or when viewing a sales listing.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A computer implemented method for creating an online sales listing for an item, the method comprising:
receiving information entered into a computer by a seller, said information describing the item for sale;
determining a comparative market value for the item based upon the information entered by the seller;
causing the comparative market value for the item to be displayed to the seller in a manner such that the seller may utilize the comparative market value to determine and finalize a set sales price for the item without linking to a third party website; and
receiving the set sales price for the item entered by the seller using the computer.

2. The method of claim 1, further comprising the step of displaying the online sales listing to a potential buyer along with the comparative market value.

3. The method of claim 1, wherein the comparative market value for the item comprises a trade-in value for the item.

4. The method of claim 1, wherein the comparative market value for the item comprises a low value for the item.

5. The method of claim 1, wherein the comparative market value for the item comprises a high value for the item.

6. The method of claim 1, wherein the comparative market value for the item comprises an average value for the item.

7. The method of claim 1, wherein the comparative market value for the item comprises a trade-in value, a low value, a high value, and an average value.

8. The method of claim 1, further comprising the step of receiving digital images of the item from the seller and including the digital images in the online sales listing.

9. The method of claim 1, further comprising the step of generating a preview of the online sales listing.

10. A computer implemented method for facilitating the placement of an online sales listing for an item, the method comprising:
receiving the sales listing for the item, said sales listing lacking a set sales price for the item;
determining a comparative market value for the item based upon information in the sales listing;
causing the comparative market value of the item to be displayed to the seller in a manner such that the seller may utilize the comparative market value to finalize the set sales price for the item;
receiving the set sales price for the item from the seller; and
causing the sales listing and the set sales price to be displayed to potential buyers of the item.

11. The method of claim 10, further comprising the step of displaying the comparative market value of the item to the buyer.

12. The method of claim 10, wherein the comparative market value for the item comprises a trade-in value for the item.

13. The method of claim 10, wherein the comparative market value for the item comprises a low value for the item.

14. The method of claim 10, wherein the comparative market value for the item comprises a high value for the item.

15. The method of claim 10, wherein the comparative market value for the item comprises an average value for the item.

16. The method of claim 10, wherein the comparative market value for the item comprises a trade-in value, a low value, a high value, and an average value.

17. The method of claim 10, further comprising the step of receiving digital images of the item from the seller and including the digital images in the online sales listing.

18. The method of claim 10, further comprising the step of generating a preview of the online sales listing.

19. A computer implemented method for facilitating the placement of an online sales listing for an item, the method comprising:
providing an electronic data entry form, said electronic data entry form allowing a seller to identify features of the item;
receiving the features of the item entered by the seller through the electronic data entry form;
determining a comparative market value for the item based upon the features of the item;
causing the comparative market value for the item to be displayed to the seller in a manner such that the seller may utilize the comparative market value to finalize a set sales price for the item;
receiving the set sales price for the item; and
generating the online the sales listing utilizing the features of the item and the set sales price.

20. The method of claim 19, further comprising the step of displaying the sales listing to a potential buyer along with the comparative market value.

21. The method of claim 19, wherein the comparative market value for the item comprises a trade-in value for the item.

22. The method of claim 19, wherein the comparative market value for the item comprises a low value for the item.

23. The method of claim 19, wherein the comparative market value for the item comprises a high value for the item.

24. The method of claim 19, wherein the comparative market value for the item comprises an average value for the item.

25. The method of claim 19, wherein the comparative market value for the item comprises a trade-in value, a low value, a high value, and an average value.

26. The method of claim 19, further comprising the step of receiving digital images of the item uploaded by the seller and including the digital images in the online sales listing.

27. The method of claim 19, further comprising the step of generating a preview of the online sales listing.

28. A system for facilitating online sales transactions between sellers and buyers, said system comprising:
means for providing an electronic data entry form over a network to remote computing devices, said electronic data entry form allowing sellers to enter descriptions of items for sale through the remote computing devices;
means for determining comparative market values of the items for sale based upon their descriptions entered by the sellers;
means for causing the comparative market values to be displayed to sellers in a manner such that the sellers may utilize the comparative market values to finalize set sales prices for the items;
means for receiving the set sales prices for the items entered by the sellers;
means for generating online sales listings for the items from the descriptions and the set sales prices; and
means for storing the online sales listings in a searchable database.

29. The system of claim 28, further comprising a means for displaying the sales listings to the buyers in conjunction with the comparative market values.

30. The system of claim 28, wherein the comparative market values for the items comprise trade-in values for the items.

31. The system of claim 28, wherein the comparative market values for the items comprise low values for the items.

32. The system of claim 28, wherein the comparative market values for the items comprise high values for the items.

33. The system of claim 28, wherein the comparative market values for the items comprise average values for the items.

34. The system of claim 28, wherein the comparative market values for the items comprise trade-in values, low values, high values, and average values.

35. The system of claim 28, further comprising a means for allowing sellers to upload digital images.

36. The method of claim 1, wherein the method further comprises generating the online sales listing for the item from the information and the set sales price entered by the seller; and
storing the online sales listing in a searchable database.
